(19) United States
(12) Patent Application Publication
(10) Pub. No.: US 2010/0213207 A1
(43) Pub. Date: Aug. 26, 2010

(54) Detachable Sanitary Cover for Dispenser and Method of Using Same

(76) Inventor: William N. Lewis, Hamilton Square, NJ (US)

Correspondence Address: PHILIP H. BURRUS, IV, 460 Grant Street, Atlanta, GA, 30312, US

(21) Appl. No.: 12/392,619

(22) Filed: Feb. 25, 2009

(51) Int. Cl. B67D 5/06; B67D 5/32

(52) U.S. Cl. 222/1; 222/562; 222/182; 222/23

(57) ABSTRACT

A detachable cover (100) for a dispenser actuation control (205) of a dispenser (200) is provided. The detachable cover (100) can be removably coupled to the dispenser actuation control (205) so as to provide a sanitary dispenser actuation control surface to a user. The detachable cover (100) can include a face (102) and one or more sidewalls (104). The detachable cover (100) can be disposable, or alternatively can be reusable in that it can be washed and sanitized. The detachable cover (100) can have a first use indicator (701) coupled thereto to indicate to a user that the dispenser actuation control surface is clean and ready for use.

### BACKGROUND

1. Technical Field

This invention relates generally to dispensing devices, and more particularly to a detachable cover for the actuator of a dispensing device that provides a sanitary actuation surface to a user.

2. Background Art

In facilities used by multiple people, such as bathrooms in hotels, it is necessary to clean the bathroom after one guest leaves and another guest arrives. For example, the tub and toilet may be scrubbed down and the linens changed when one guest checks out to ensure that the facilities are clean for the next guest. This step of cleaning is labor intensive, and is often one of the major operating costs associated with such a facility.

Most hotels are conscientious when cleaning rooms between guests. However, despite the thoroughness with which they clean, some consumers are beginning to demand additional assurances that the room has been cleaned upon entering a room. For example, some guests prefer a new, unopened, and unused roll of toilet paper. Some guests prefer that consumables, such as soap, shampoo, and lotion, be completely replaced with individualized, unopened, new containers of such product. Other guests prefer linens to be bound with paper ribbon or string to show that they have not been used.

Satisfying these needs can be costly. For example, if a typical user consumes one-third of a bottle of shampoo, the hotel must discard two-thirds of the bottle when the guest leaves. It would be advantageous to employ a dispenser that could be used by multiple guests, thereby reducing the cost associated with discarded product. However, it can be difficult to identify that an immovable fixture has been cleaned. For instance, it is hard to mark a tub or sink with a marking that says, “Cleaned and Ready for Use.” The same holds true with dispensers.

There is thus a need for a dispenser that can both be cleaned and identified as such between users.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates one embodiment of a detachable cover for a dispenser in accordance with embodiments of the invention.

FIG. 2 illustrates one embodiment of a dispenser in accordance with embodiments of the invention.

FIG. 3 illustrates one embodiment of a detachable cover coupled to a dispenser actuator in accordance with embodiments of the invention.

FIG. 4 illustrates one embodiment of a detachable cover for a dispenser in accordance with embodiments of the invention.

FIG. 5 illustrates one embodiment of a detachable cover for a dispenser in accordance with embodiments of the invention.

FIG. 6 illustrates one embodiment of a detachable cover coupled to a dispenser actuator on a dispenser in accordance with embodiments of the invention.

FIG. 7 illustrates one embodiment of a detachable cover for a dispenser having a first use indicator in accordance with embodiments of the invention.

FIG. 8 illustrates one embodiment of a detachable cover in accordance with embodiments of the invention.

FIG. 9 illustrates one embodiment of a detachable cover being coupled to a dispenser in accordance with embodiments of the invention.

FIG. 10 illustrates one embodiment of a dispenser having a detachable cover coupled to its actuator in accordance with embodiments of the invention.

FIG. 11 illustrates one embodiment of a dispenser and detachable actuator cover in accordance with embodiments of the invention.

FIG. 12 illustrates one method for using embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the present invention provide a removable cover capable of attaching to the dispensing control of a dispenser. In one embodiment, the removable cover comprises a rigid material, such as a thermoplastic, that is geometrically configured to correspond to the shape of the dispenser actuator such that the removable cover can be nested atop the dispenser actuator. In so doing, the removable cover can be attached to the dispenser actuator, thereby providing a sanitary surface for guests using the dispenser.

In one embodiment, the removable cover is disposable. The removable cover can be manufactured from inexpensive materials, and thus can be used as a “one-time-use” cover. Where used with a liquid dispenser in a hotel, for example, the cleaning staff can remove a used cover from the dispenser actuator when a guest leaves. The cleaning staff can then discard the used cover and can attach a new, unused removable cover to the dispenser actuator. The guest then has the benefit of a clean, unused surface with which to dispense product. At the same time, the hotel has the benefit of not having to discard partially used products, such as soaps, lotions, and shampoos.

In another embodiment, the removable cover is washable. Continuing the hotel example from the preceding paragraph, when a guest vacates a room, the cleaning staff can remove the cover from the dispenser actuator. A new, clean one can then be attached to the dispenser actuator. The cleaning staff can then sanitize the used cover by washing, dipping, or otherwise cleaning the cover. Additionally, the cover can be treated with antibacterial, antimicrobial, or antifungal agents. After the cover has been sanitized, the cleaning staff can apply it to a dispenser so as to provide the guest with a fresh, clean operating surface.

In one embodiment, the removable cover can have a “first use” or “sanitized” identifier disposed thereon. For instance, in one embodiment, the first use identifier comprises an adhesive label having text disposed thereon. The text may read, “Certified Sanitized,” or “Cleaned and Ready for Use,” thereby alerting guests that the dispenser is unused. In another embodiment, the first use identifier comprises a shrink-wrapped layer of material, such as plastic, which a guest tears off prior to using the dispenser. As with the label, the shrink-wrapped layer may include printing that alerts the guest either to remove the shrink-wrapped layer or that the dispenser actuator is ready for first use.

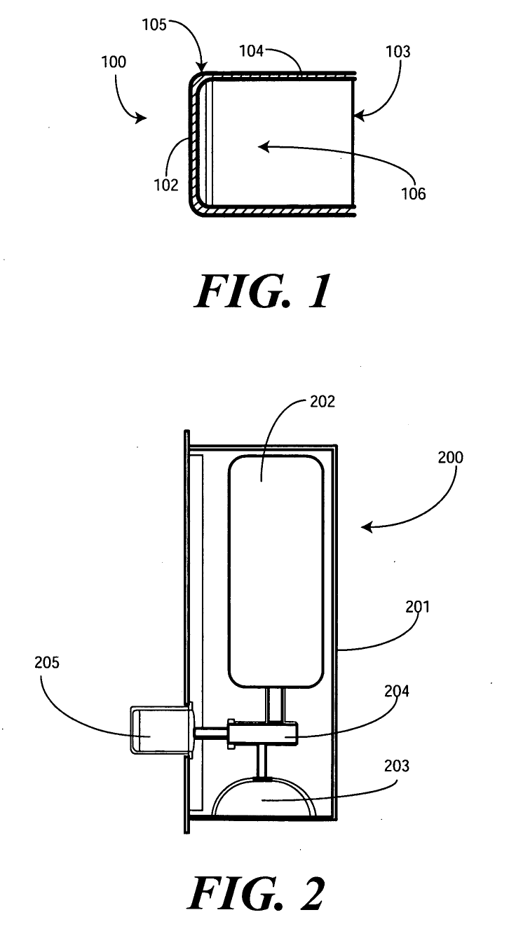

Turning now to FIG. 1, illustrated therein is one embodiment of a detachable cover 100 in accordance with embodiments of the invention. The detachable cover 100 is configured to be removably attached to a dispenser actuation control of a dispenser. For example, where the dispenser is a push-button operated liquid dispenser, such as a soap or shampoo dispenser in a hotel, the detachable cover 100 can be configured to removably attach to the push-button actuator of the dispenser. Similarly, where the dispenser is a slide operated paper towel dispenser, the detachable cover 100 can be configured to removably attach to the slide actuator. In either case, the detachable cover 100, in one embodiment, is intended to be applied to the dispenser actuation control for each user or group of users so as to provide a sanitary dispenser actuator control surface.

In one embodiment, the detachable cover 100 includes a unitary cover member 101. The unitary cover member 101 can be rigid, or can be manufactured form a compliant material. By way of example, in one embodiment the unitary cover member 101 is manufactured from a rigid material, such as polycarbonate, styrene, ABS, polycarbonate-ABS, or other thermoplastic material by way of an injection molding process. In another embodiment, the unitary cover member 101 can be manufactured from a shape-retaining, yet compliant material, such as silicone.

The unitary cover member 101 includes a face 102 and at least one sidewall 104. The sidewall 104 can be continuous, such as where the face 102 has a round shape, which may be a circle, oval, or abstract curved shape. The sidewall 104 can also comprise multiple sidewalls, such as where the face 102 has a rectangular, square, or other polygonal or abstract shape.

The sidewall 104 extends distally from the face 102 and extends between the face 102 and a dispenser actuation control receiving opening 103, which is located at a distal end relative to the face 102. The face 102 and sidewall 104 thus define an interior and an exterior of the unitary cover member 101. To the exterior, an outer sanitary dispenser actuator control surface 105 is provided. To the interior, an orifice 106 is provided. In one embodiment, the orifice 106 begins at the dispenser actuator control receiving opening 103 and extends into the unitary cover member 101.

In one embodiment, the face 102 has a planar surface when viewed in cross section, as shown in FIG. 1. In another embodiment, the face 102 has a concave or convex, non-planar surface. It will be clear to those of ordinary skill in the art having the benefit of this disclosure that the face 102 can take a variety of geometric configurations, depending upon the dispenser to which it is attached.

Similarly, the face 102 can take a variety of shapes when viewed in the plan view. For example, in one embodiment, the face 102 is oval in shape or circular in shape. In another embodiment the face 102 is square or rectangular in shape. The face can take free form or other shapes as desired by a particular application.

In one embodiment, the unitary cover member 101 is physically and geometrically shaped so as to replicate the dispenser actuator control to which it is to be attached. In so doing, the unitary cover member 101 mirrors the shape of the dispenser actuator control so as to be able to “nest” atop the dispenser actuator control. As such, the unitary cover member forms a sanitary “skin” atop the dispenser actuator control that provides the user with a sanitary surface, yet without adding additional bulk or weight to the dispenser actuator control. In such an embodiment, the shape of the face 102 and sidewall(s) 104 will be determined by the shape of the dispenser actuator control.

Turning now to FIG. 2, illustrated therein is one embodiment of a dispenser 200 suitable for use with embodiments of the invention. In one embodiment, the dispenser 200 is configured to dispense liquid-based, gel-based, or foam-based products like soap, shampoo, or lotion. In another embodiment, the dispenser 200 is configured to dispense other products, such as paper-based products like paper towels. For simplicity of discussion, a liquid based dispenser will be used herein as an illustrative example. It is intended that this illustrative example not limit the scope of the invention, as the invention is defined solely by the appended claims including any amendments made during the pendency of this application and all equivalents of those claims as issued. It will further be clear to those of ordinary skill in the art having the benefit of this disclosure that the detachable cover (100) described herein can be used with a wide variety of dispensers.

As shown in FIG. 2, the dispenser 200 includes a housing 201, a container 202 disposed within the housing for receiving a dispensable product, and an outlet 203 through which the dispensable product is delivered from the dispenser 200. In one embodiment, the outlet 203 is recessed into the housing so that the user need not come in contact with the outlet 203 when dispensing the product.

Where the dispenser 200 is configured to deliver a liquid-based dispensable product, such as soap, the container 202 may be an enclosed container suitable for holding such materials. Further, where the dispenser 200 is configured to deliver a liquid-based dispensable product, the dispenser may include a dispenser valve 204 that is coupled to the container. In one embodiment, the dispenser valve 204 is configured to dispense discrete amounts of the dispensable product through the outlet 203 to a user.

A user causes the dispenser 200 to dispense the dispensable product by way of a dispenser actuation control 205. The dispenser actuation control 205, which may be a push-button type, slider-type, rotary-type or other type, effects the dispensing of the dispensable product through the outlet 203. In one embodiment, the dispenser actuation control 205 protrudes from the housing 201 so that it is easily actuated by a user. The user manually actuates the dispenser actuation control 205 to dispense the dispensable product.

Where the dispenser 200 includes the dispenser valve 204, the dispenser actuation control 205 is coupled to the dispenser valve 204 for opening and closing the dispenser valve 204. Where the dispenser actuation control 205 is a push-button type control, a user may push the dispenser actuation control 205 into the dispenser 200 so as to dispense the dispensable product through the outlet 203.

In one embodiment, the dispenser 200 is manufactured from a rigid material. For example, the dispenser 200 may be manufactured from a thermoplastic. Alternatively, the dispenser 200 may be manufactured from metal. Additionally, some parts of the dispenser 200 may be manufactured from one material, while other parts are manufactured from another material. For instance, the housing 201 may be manufactured from metal while the container 202 is manufactured from plastic, and so forth.

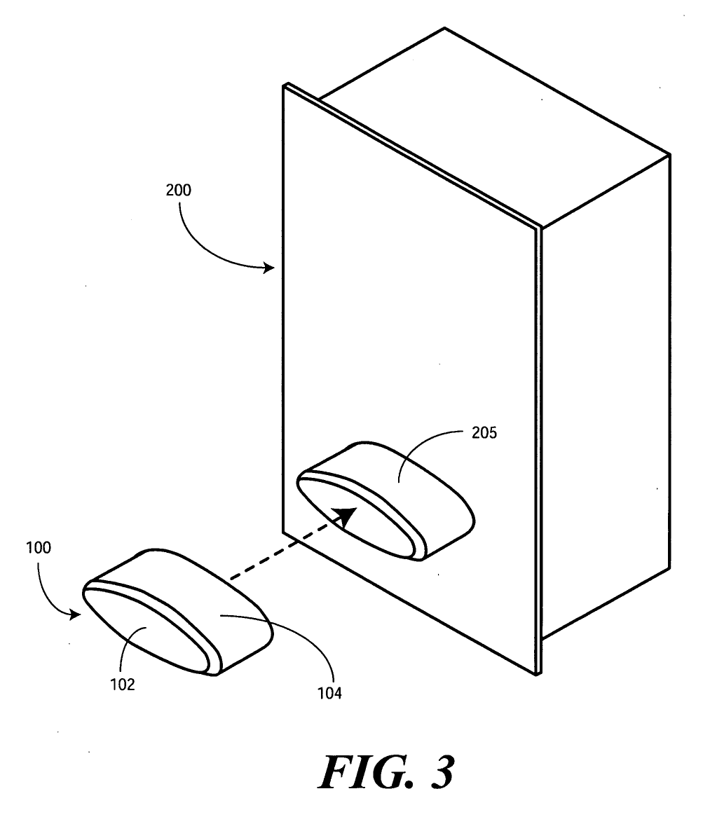

Turning now to FIG. 3, in accordance with embodiments of the invention, a detachable cover 100 can be coupled to the dispenser actuation control 205 of the dispenser 200. By coupling a clean, unused detachable cover 100 to the dispenser actuation control 205, a user can be assured that the surface is sanitary for use. By removing and discarding the detachable cover 100, or optionally removing and cleaning the detachable cover 100, a host can ensure that the dispenser actuation control 205 is free from bacteria, dirt, or other microbial matter. Thus, the detachable cover 100 provides a sanitary dispenser actuation control surface for a user.

As shown in the illustrative embodiment of FIG. 3, the face 102 of the detachable cover 100 has an oval, planar surface that replicates the surface of the dispenser actuation control 205. Similarly, the detachable cover 100 has a sidewall 104 that is one continuous sidewall extending distally from the face 102. In this configuration, the detachable cover 100 replicates the shape of the dispenser actuation control 205 so as to nest about the dispenser actuation control 205.

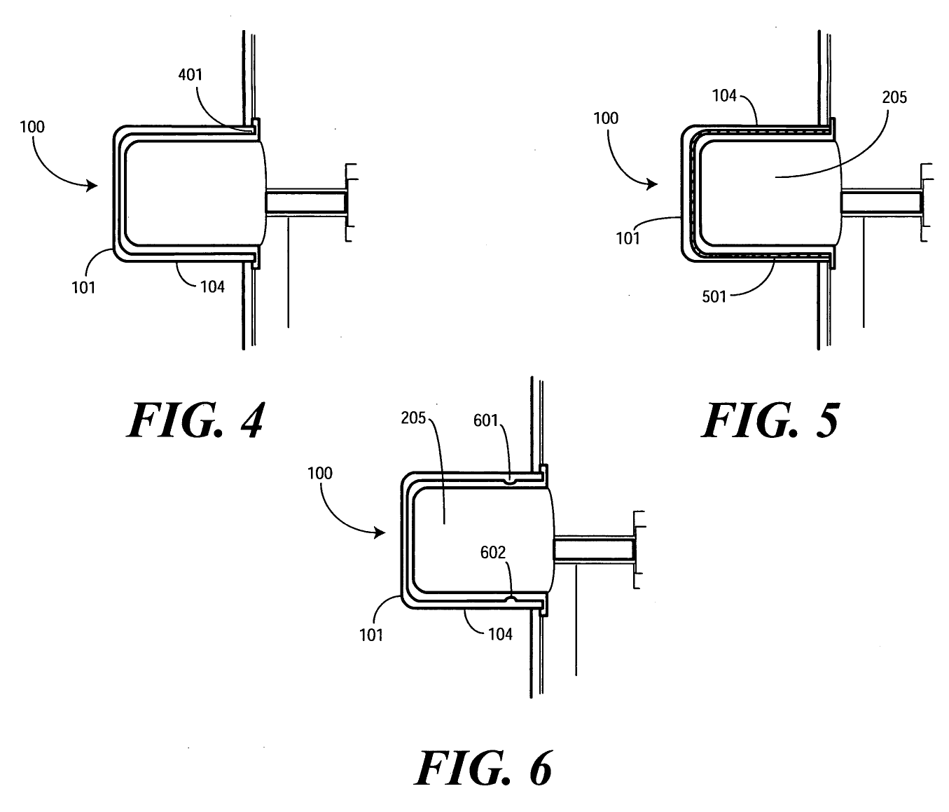

Turning now to FIGS. 4-6, illustrated therein are various modes of coupling the detachable cover 100 to the dispenser actuation control 205. It will be clear to those of ordinary skill in the art having the benefit of this disclosure that embodiments of the invention are not limited to only these modes, as others may also be used. FIGS. 4-6 illustrate exemplary modes only.

In one embodiment, the detachable cover 100 includes an attachment device 401,501,601 for removably coupling to the dispenser actuation control. The attachment device 401,501,601 can be coupled to the unitary cover member 101 of the detachable cover 100. In one embodiment, the attachment device 401,501,601 is configured so that the detachable cover can be attached to, and removed from, the dispenser actuation control 205.

In the embodiment of FIG. 4, the attachment device 401 comprises a friction engagement configured to exert a retaining force on the dispenser actuation control 205. For example, the friction engagement may be due to the sidewall 104 of the detachable cover 100 pressing against the sidewalls of the dispenser actuation control 205. Alternatively, as shown in FIG. 4, the friction engagement may be due to a portion of the detachable cover engaging with a mechanical or other feature of the dispenser actuation control 205.

In the embodiment of FIG. 5, the attachment device 501 comprises a releasable adhesive. Such an adhesive holds the detachable cover 100 against the dispenser actuation control 205 sufficiently for normal use. However, the binding force of the adhesive can be overcome when, for instance, cleaning staff desires to remove the detachable cover from the dispenser actuation control 205.

In the embodiment of FIG. 6, the attachment device 601 comprises a mechanical protrusion configured to engage a correspondingly shaped recess 602 of the dispenser actuation control 205. While the protrusion and recess 602 are shown as extending from the sidewall 104, it will be clear to those of ordinary skill in the art having the benefit of this disclosure that the invention is not so limited. Mechanical retaining features can be placed on various locations across the detachable cover 100.

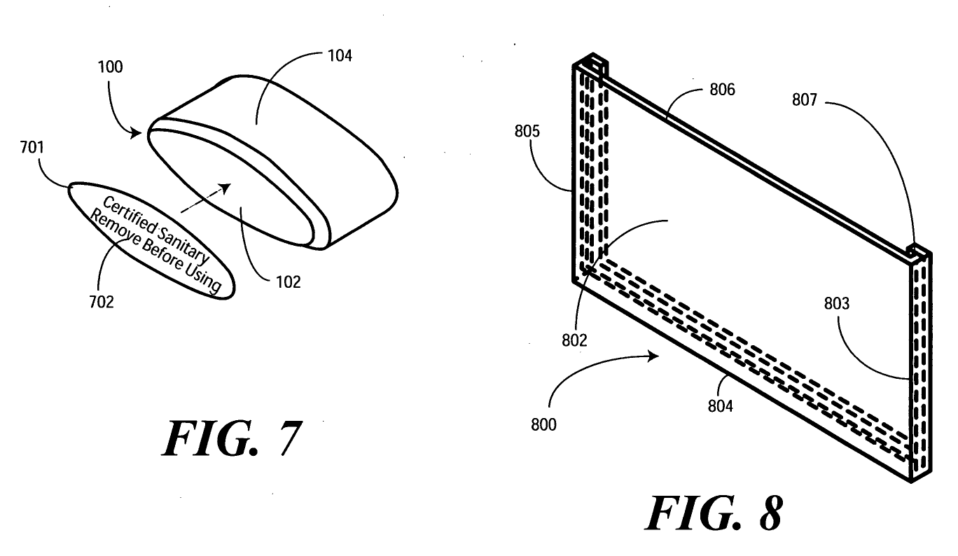

Turning now to FIG. 7, illustrated therein is one embodiment of a detachable cover 100 configured to provide a first use notice to a user. In the illustrative embodiment of FIG. 7, the a removable first use indicator 701 is provided. The removable first use indicator 701 may optionally have text 702 disposed thereon. By way of example, the text may read, “Certified Sanitary—Remove Before Using.” Alternatively, other indicia of first use or sanitary state can be disposed upon the first use indicator 701.

The first use indicator 701, in one embodiment, is disposed along the face 102 of the detachable cover 100. Alternatively, the first use indicator 701 may be wrapped about the sidewall 104. In one embodiment, the first use indicator 701 comprises a sticker that can be adhesively attached to the face 102 of the detachable cover so as to let the user know that the outer surface of the detachable cover 100 is sanitary.

In one embodiment, the detachable cover 100 is disposable. As such, the manufacturer may place the first use indicator 701 on the detachable cover 100 prior to shipment to the end user. In another embodiment, the detachable cover is washable and reusable. In such a configuration, the manufacturer may initially attach a first use indicator 701 to the detachable cover, but may also send additional first use indicators to the end user such that they may be applied to the detachable cover 100 once it has been cleaned or sanitized.

In one embodiment, the first use indicator 701 is removable such that a user can remove the first use indicator 701 from the detachable cover 100 prior to use. The user is thus assured that the detachable cover is unused while the first use indicator 701 remains on the detachable cover 100.

Turning now to FIG. 8, illustrated therein is an alternate embodiment of a detachable cover 800 in accordance with embodiments of the invention. As dispensers and dispenser actuation controls can take a variety of shapes and geometric configurations, so too can the detachable cover 800.

In FIG. 8, the detachable cover 800 has a face 802 that is configured as a rectangular, planar surface. Further, the detachable cover 800 has three sidewalls 803,804,805. Each of the three sidewalls 803,804,805 is coupled to a respective side of the face 802 and extends distally from the face 802. One edge 806 of the face 802, in this illustrative embodiment, does not include a sidewall so that the detachable cover 800 may easily nest about a corresponding dispenser actuation control 205.

The detachable cover 800 of FIG. 8 also includes an alternative attachment device 807. In this embodiment, the attachment device 807 comprises a relief member that is configured to receive at least three edges of a dispenser actuation control.

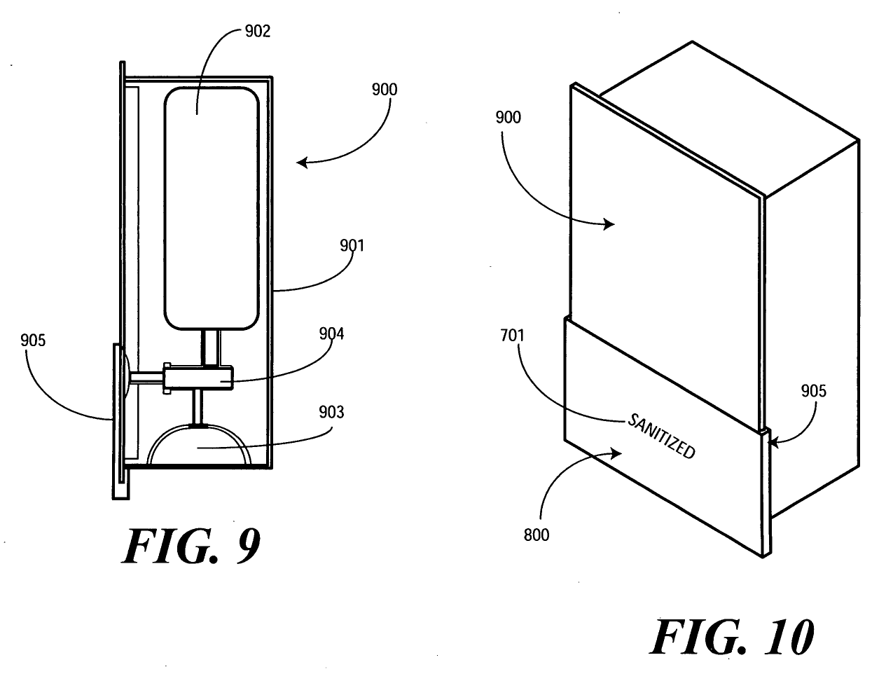

Turning now to FIGS. 9 and 10, illustrated therein are a dispenser 900 suitable for use with the detachable cover (800) of FIG. 8, and the dispenser having the detachable cover 800 attached thereto, respectively. In FIG. 9, as with FIG. 2, the dispenser 900 includes a housing 901, a container 902 disposed within the housing 900 for receiving a dispensable product, and an outlet 903 through which the dispensable product is delivered to a user. A dispenser actuation control 905 effects dispensing of the dispensable product through the outlet 903. In FIG. 10, the detachable cover 800 has been removably coupled to the dispenser actuation control 905. Further, the detachable cover 800 includes a first use indicator 701 disposed thereon.

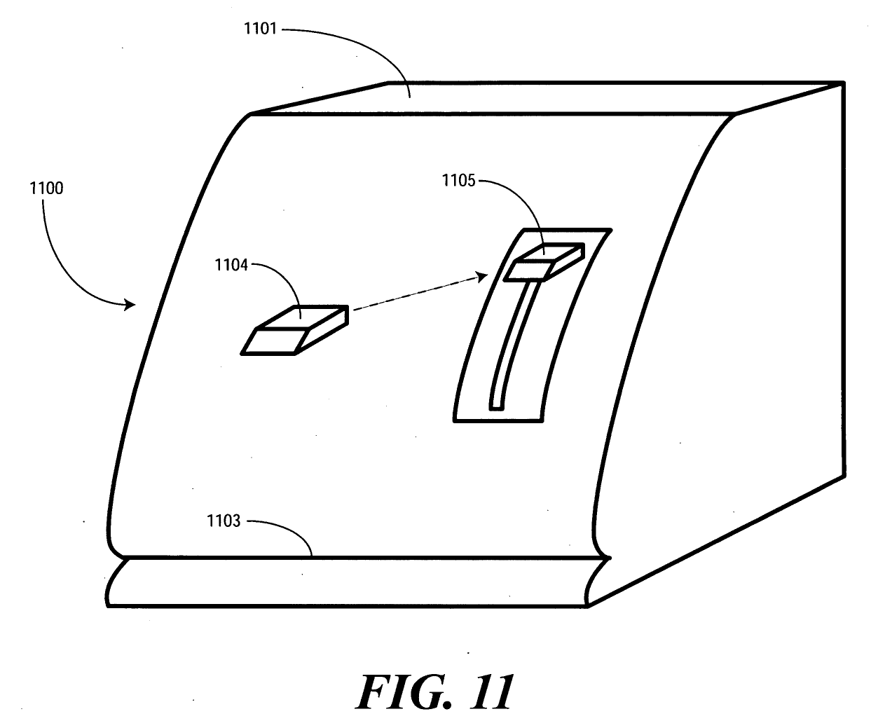

Turning now briefly to FIG. 11, illustrated therein is an alternate dispenser 1100 suitable for use with embodiments of the invention. Specifically, in FIG. 11 the dispenser 1100 is a paper towel dispenser. The dispenser actuation control 1105 is a slidable feature protruding from the housing 1101 of the dispenser so as to be manually actuated to dispense paper towels through an outlet 1103. The detachable cover 1104 can be removably coupled to the dispenser actuation control 1105, thereby providing a sanitary dispenser actuation control surface to a user.

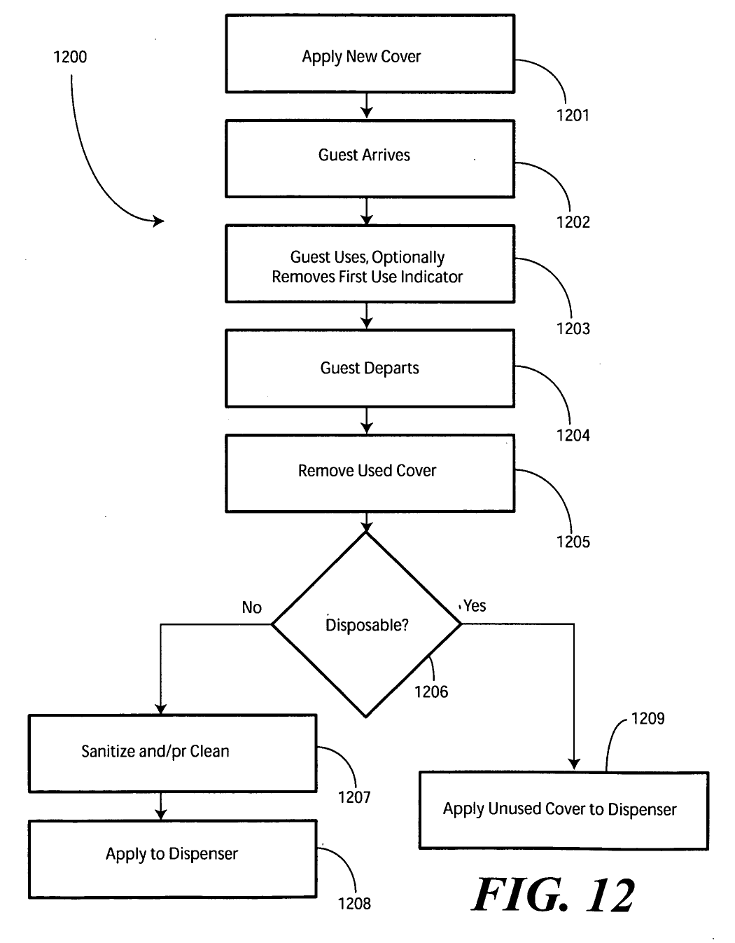

Turning now to FIG. 12, illustrated therein is one method 1200 of providing a sanitary dispenser actuation control surface of a dispenser in accordance with embodiments of the invention. For example, in one embodiment the method 1200 of FIG. 12 is suitable for providing a sanitary control surface of a liquid dispenser, such as a soap dispenser, to a guest in a hotel.

At step 1201, a new, or alternatively a reused but sanitized, disposable cover is applied to a dispenser actuation control of a dispenser. Continuing with the hotel example, at step 1202 the guest would check-in to the room, thereby discovering a dispenser having a sanitary dispenser actuation control surface that is ready for use.

At step 1203, the guest uses the dispenser. This may include the step of removing a first use indicator from the detachable cover mounted atop the dispenser actuation control. At step 1204, the guest checks-out of the hotel.

At step 1205, the cleaning staff removes the used detachable cover that is nested on the dispenser actuation control from the dispenser actuation control. As noted above, the detachable cover may be disposable. Alternatively, it may be reusable and capable of being cleaned and sanitized. This is determined at decision 1206.

Where the detachable cover is disposable, the staff may prepare the dispenser for another guest at step 1209 by coupling an unused, detachable cover on the dispenser actuation control of the dispenser, thereby transforming the dispenser actuation control from an initially used state to an unused state.

Where the detachable cover is reusable, the staff may prepare the dispenser for another guest at step 1207 by washing or otherwise sanitizing the disposable cover. This step may also include attachment of a first-use indicator to the detachable cover. At step 1208, the staff may then couple the sanitized and thus unused, detachable cover on the dispenser actuation control of the dispenser, thereby transforming the dispenser actuation control from an initially used state to an unused state.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention

What is claimed is:

1. A detachable cover for a dispenser actuation control for providing a sanitary dispenser actuator control surface to a user, the detachable cover comprising:
a unitary cover member having a face and a dispenser actuation control-receiving opening;
at least one sidewall extending between the face and the dispenser actuation control receiving opening, thereby defining a outer sanitary dispenser actuator control surface and an orifice beginning at the dispenser actuation control receiving opening and extending into the unitary cover member, wherein the orifice is geometrically configured such that the dispenser actuation control can nest within the orifice of the unitary cover member; and
an attachment device, coupled to the unitary cover member and configured to releasably retain the unitary cover member to the dispenser actuation control.

2. The detachable cover of claim 1, wherein the attachment device comprises a friction engagement configured to exert a retaining force on the dispenser actuation control.

3. The detachable cover of claim 1, wherein the attachment device comprises a releasable adhesive.

4. The detachable cover of claim 1, wherein the attachment device comprises a mechanical protrusion configured to engage a correspondingly shaped recess of the dispenser actuation control.

5. The detachable cover of claim 1, further comprising a removable first use indicator disposed along the face on the outer sanitary dispenser actuator control surface.

6. The detachable cover of claim 5, wherein the removable first use indicator is adhesively coupled to the face.

7. The detachable cover of claim 1, wherein the detachable cover is disposable.

8. The detachable cover of claim 1, wherein the face comprises an oval, planar surface, further wherein the at least one sidewall comprises a continuous sidewall extending distally from the face.

9. The detachable cover of claim 1, wherein the face comprises a rectangular, planar surface, further wherein the at least one sidewall comprises three sidewalls, with each of the three sidewalls coupled to a respective side of the face and extending distally therefrom.

10. The detachable cover of claim 9, wherein the attachment device comprises a relief member configured to receive at least three edges of the dispenser actuation control.

11. A dispenser, comprising:
a housing;
a container disposed within the housing for receiving a dispensable product;
an outlet through which the dispensable product is delivered from the dispenser;
a dispenser actuation control effecting dispensing the dispensable product through the outlet, and protruding from the housing so as to be manually actuated to dispense discrete amounts of the dispensable product through the outlet; and
a detachable cover coupled to the dispenser actuation control, thereby providing a sanitary dispenser actuation control surface to a user.

12. The dispenser of claim 11, wherein the dispensable product comprises at least one of a liquid based product, a gel based product, or a foam based product, further comprising a dispenser valve coupled to the container, wherein the dispenser actuation control is coupled to the dispenser valve and comprises a push actuated dispenser valve control for effecting operation thereof, wherein the push actuated dispenser valve control is pushable into the dispenser to dispense the discrete amounts of the dispensable product through the outlet.

13. The a dispenser of claim 12, wherein the detachable cover comprises a face and at least one sidewall extending from the face and terminating so as to define a push actuated dispenser valve control receiving opening and an interior region geometrically configured to nest about the push actuated dispenser valve control.

14. The dispenser of claim 13, wherein the detachable cover is manufactured from a rigid material, wherein the rigid material comprises a thermoplastic.

15. The dispenser of claim 11, wherein the outlet is recessed into the housing.

16. The dispenser of claim 13, wherein the detachable cover is manufactured from a compliant material, wherein the compliant material comprises silicone.

17. The dispenser of claim 13, further comprising an attachment device configured to releasably retain the detachable cover to the push actuated dispenser valve control.

18. The dispenser of claim 17, further comprising a removable first use indicator disposed along the face.

19. A method of providing a sanitary dispenser actuation control surface of a liquid dispenser to a guest in a hotel, the method comprising:
removing a used, detachable cover, nested with a dispenser actuation control of the liquid dispenser, from the dispenser actuation control; and
coupling an unused, detachable cover on the dispenser actuation control of the liquid dispenser, thereby transforming the dispenser actuation control from an initially guest used state to an unused state.

20. The method of claim 19, further comprising:
cleaning the used, detachable cover so as to transform the used, detachable cover to a sanitized, detachable cover;
attaching a first use indicator to a face of the sanitized, detachable cover; and
coupling the sanitized, detachable cover to one of the dispenser actuation control of the liquid dispenser or another dispenser actuation control of another liquid dispenser.
